(19) United States
(12) Patent Application Publication
(10) Pub. No.: US 2013/0242237 A1
(43) Pub. Date: Sep. 19, 2013

(54) LIQUID CRYSTAL DISPLAY APPARATUS INCLUDING INTERFERENCE FILTERS

(71) Applicants: Hitoshi NAGATO, Kunitachi-shi (JP); Takashi Miyazaki, Kawasaki-shi (JP); Rei Hasegawa, Yokohama-shi (JP); Koji Suzuki, Yokohama-shi (JP); Yuko Kizu, Yokohama-shi (JP); Masaki Atsuta, Yokosuka-shi (JP)

(72) Inventors: Hitoshi NAGATO, Kunitachi-shi (JP); Takashi Miyazaki, Kawasaki-shi (JP); Rei Hasegawa, Yokohama-shi (JP); Koji Suzuki, Yokohama-shi (JP); Yuko Kizu, Yokohama-shi (JP); Masaki Atsuta, Yokosuka-shi (JP)

(21) Appl. No.: 13/718,601

(22) Filed: Dec. 18, 2012

(30) Foreign Application Priority Data
Mar. 14, 2012 (JP) 2012-057421

(51) Int. Cl. G02F 1/1335

(52) U.S. Cl. CPC G02F 1/133509
USPC 349/105

(57) ABSTRACT

According to one embodiment, a liquid crystal display apparatus includes an interference filter, a transistor, a substrate, and a liquid crystal layer. The interference filter includes a first area and a second area. The first area transmits light in a first wavelength band and reflects light except the first wavelength band. The second area transmits white light. The transistor is provided on the first area and the second area. The substrate faces the interference filter. The liquid crystal layer is provided between the interference filter and the substrate.

### CROSS-REFERENCE TO RELATED APPLICATIONS

This application is based upon and claims the benefit of priority from Japanese Patent Application No. 2012-057421, filed Mar. 14, 2012, the entire contents of which are incorporated herein by reference.

### FIELD

Embodiments described herein relate generally to a liquid crystal display apparatus including interference filters.

### BACKGROUND

A display apparatus including a liquid crystal display has increased in demand more and more with the diffusion of terrestrial digital broadcasting, the Internet, and cellular phones. There are increasing demands for various sizes of displays such as compact displays used for mobile devices and large displays used for large-screen televisions.

A liquid crystal display is designed to perform color display by causing white light emitted from a backlight to emerge through a color filter. As a conventional color filter, absorption filters using pigments or dyes are used. When white light passes such an absorption filter, the filter absorbs light components except the transmission wavelength region of the filter. When, for example, white light passes through a blue absorption filter, green and red light components are absorbed by the filter. Likewise, when white light passes through a green absorption filter, red and blue light components are absorbed by the filter. When white light passes through a red absorption filter, green and blue light components are absorbed by the filter. As a consequence, the light utilization efficiency of a liquid crystal display apparatus using absorption filters is ⅓ that of an apparatus using no absorption filters.

There is proposed a scheme of providing white sub-pixels in addition to red, blue, and green sub-pixels to improve the light utilization efficiency. White sub-pixels are, for example, sub-pixels provided with no absorption filters. It is therefore possible to bring out light from white sub-pixels without any loss.

Providing white sub-pixels can improve the light utilization efficiency. Note however that light passing through red, blue, and green sub-pixels is attenuated to ⅓. For this reason, demands have arisen for a liquid crystal display apparatus with further improved light utilization efficiency.

### BRIEF DESCRIPTION OF THE DRAWINGS

FIG. 1A is a plan view of a color filter in a liquid crystal display apparatus according to the first embodiment when viewed from the display surface of the liquid crystal display apparatus;

FIG. 1B is a sectional view taken along a line 1A-1A in FIG. 1A;

FIG. 2A is a graph showing the transmission characteristics (ordinate) of an interference filter 101 with respect to wavelengths (abscissa);

FIG. 2B is a graph showing reflection characteristics (ordinate) with respect to wavelengths (abscissa);

FIG. 3 is a graph showing an example of the transmission characteristics of an absorption filter 105;

FIG. 4 is a sectional view showing the structure of the liquid crystal display apparatus according to the first embodiment;

FIG. 5A is a view showing an example of the arrangement of an interference filter 2;

FIG. 5B is a graph showing the wavelength (abscissa) dependence of a refractive index n (ordinate) as an optical constant of the interference filter 2 as an example;

FIG. 5C is a graph showing the wavelength dependence of an extinction coefficient k as an optical constant of the interference filter 2 as an example;

FIGS. 6A, 6B, 6C, 6D, 6E, 6F, 6G, 6H, and 6I are views for explaining a manufacturing process for the first color filter;

FIG. 7A is a view showing the arrangement of filters in a case in which one pixel is constituted by only red, green and blue sub-pixels;

FIG. 7B is a view showing the arrangement of filters in a case in which one pixel is constituted by red, green, blue, and white sub-pixels;

FIG. 7C is a view showing an example of the transmittance of an absorption filter in an ideal state;

FIG. 8 is a graph showing the transmission characteristics of an absorption filter as an example;

FIG. 9A is a plan view of a color filter in a liquid crystal display apparatus according to the second embodiment when viewed from the display surface of the liquid crystal display apparatus;

FIG. 9B is a sectional view taken along a line 9A-9A in FIG. 9A;

FIGS. 10A and 10B are views for explaining a color filter arrangement of the first modification of the second embodiment;

FIGS. 11A and 11B are views for explaining the arrangement of a modification in which red, green, and blue interference filters are formed on each white pixel portion in a horizontal stripe pattern;

FIG. 12 is a view for explaining a color filter arrangement in a liquid crystal display apparatus according to the third embodiment; and

FIG. 13 is a view for explaining a color filter arrangement in a liquid crystal display apparatus according to the fourth embodiment.

### DETAILED DESCRIPTION

In general, according to one embodiment, a liquid crystal display apparatus includes an interference filter, a transistor, a substrate, and a liquid crystal layer. The interference filter includes a first area and a second area. The first area transmits light in a first wavelength band and reflects light except the first wavelength band. The second area transmits white light. The transistor is provided on the first area and the second area. The substrate faces the interference filter. The liquid crystal layer is provided between the interference filter and the substrate.

### First Embodiment

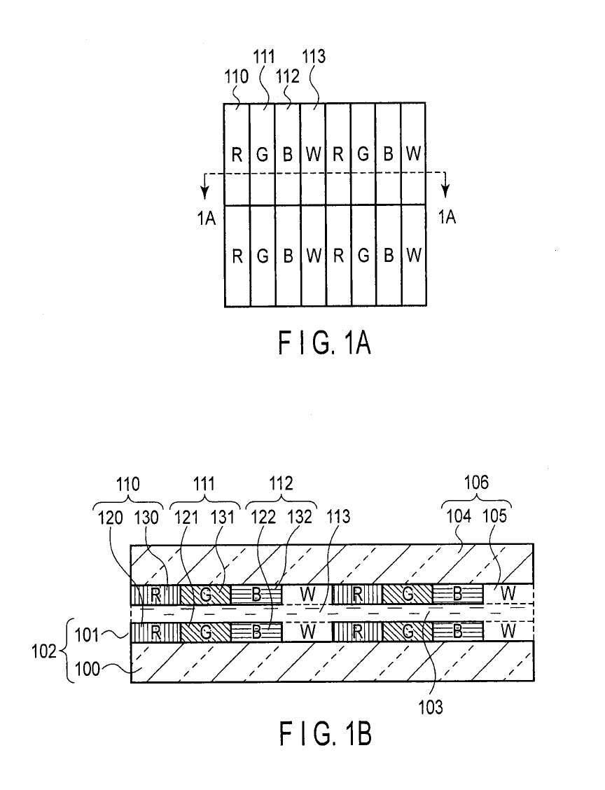

FIGS. 1A and 1B are views for explaining the basic arrangement of a color filter in a liquid crystal display apparatus according to the first embodiment.

FIG. 1A is a plan view of a color filter viewed from the display surface of the liquid crystal display apparatus. FIG. 1B is a sectional view taken along a line 1A-1A in FIG. 1A.

As shown in FIG. 1A, the liquid crystal display apparatus according to this embodiment is provided with a color filter with one pixel including four sub-pixels including a red (R) pixel 110, a green (G) pixel 111, a blue (B) pixel 112, and a white (W) pixel 113.

Roughly speaking, the liquid crystal display apparatus is formed by interposing a liquid crystal layer 103 between an array substrate 102 and a counter substrate 106. In this embodiment, color filters are formed on both the array substrate 102 and the counter substrate 106. The liquid crystal layer 103 is provided between the color filter provided on the array substrate 102 and the color filter provided on the counter substrate 106. In this case, it is possible to include other elements between the respective color filters and the liquid crystal layer 103.

As shown in FIG. 1B, a first color filter (interference filter) 101 having sub-pixels (red, green, and blue sub-pixels in the case of FIG. 1A) which transmit light of different colors and white sub-pixels for improvement in luminance is formed on a transparent glass substrate 100 as the base of the array substrate 102. More specifically, a red interference filter 120 is formed at a position corresponding to the red pixel 110, a green interference filter 121 is formed at a position corresponding to the green pixel 111, and a blue interference filter 122 is formed at a position corresponding to the blue pixel 112. On the other hand, in the first embodiment, a position corresponding to the white pixel 113 corresponds to a transparent pixel at which no interference filter is formed. That is, the first color filter includes the first area as the red interference filter 120 and the second area as a transparent pixel. The first color filter includes the third area as the green interference filter 121 and the fourth area as the blue interference filter 122.

A second color filter 105 including sub-pixels (red, green, and blue sub-pixels in the case of FIG. 1A) which transmit light of different colors corresponding to the first sub-pixels and white sub-pixels for improvement in luminance is formed on a transparent glass substrate 104 serving as the base of the counter substrate 106. More specifically, a red absorption filter 130 is formed at a position corresponding to the red pixel 110, a green absorption filter 131 is formed at a position corresponding to the green pixel 111, and a blue absorption filter 132 is formed at a position corresponding to the blue pixel 112. On the other hand, a position corresponding to the white pixel 113 corresponds to a transparent pixel on which no absorption filter is formed.

As shown in FIG. 1B, when viewed in section, the red interference filter 120 and the red absorption filter 130 vertically overlap each other, the green interference filter 121 and the green absorption filter 131 vertically overlap each other, and the blue interference filter 122 and the blue absorption filter 132 vertically overlap each other.

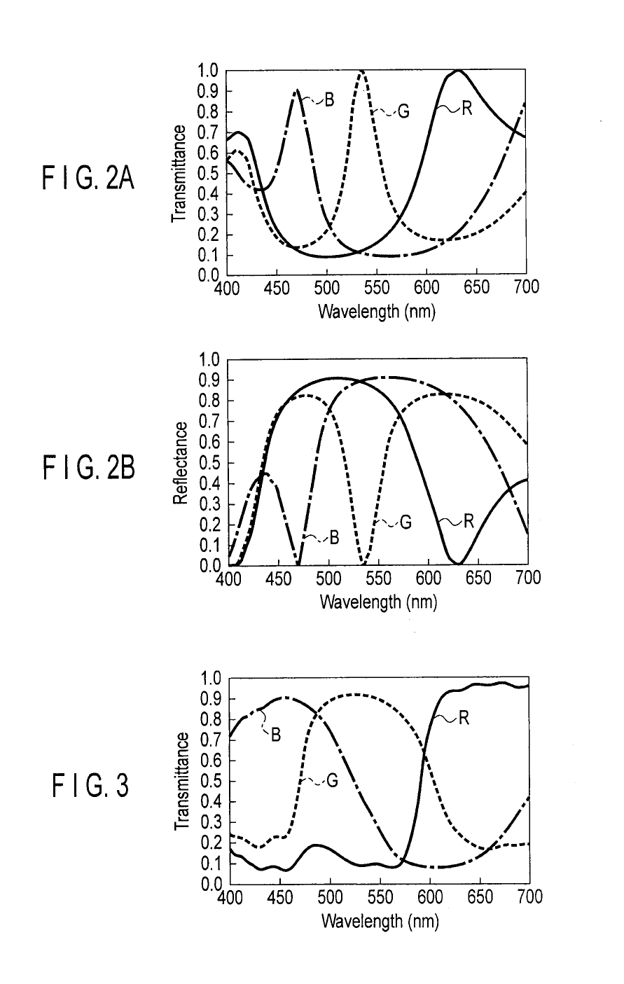

The following is an example of the first color filter 101 and second color filter 105. FIG. 2A shows an example of the transmission characteristics (ordinate) of the first color filter 101 with respect to wavelengths (abscissa). FIG. 2B shows an example of the reflection characteristics (ordinate) with respect to wavelengths (abscissa). FIG. 3 shows an example of the transmission characteristics of the absorption filter 105.

An interference filter has the characteristic of transmitting light in a specific wavelength band and reflecting light except the specific wavelength band. As shown in FIGS. 2A and 2B, for example, the red interference filter 120 corresponding to a red sub-pixel has the characteristic (R) of transmitting light in the red wavelength band and reflecting light in other color wavelength bands. Likewise, the green interference filter 121 corresponding to a green sub-pixel has the characteristic (G) of transmitting light in the green wavelength band and reflecting light in other color wavelength bands. In addition, likewise, the blue interference filter 122 corresponding to a blue sub-pixel has the characteristic (B) of transmitting light in the blue wavelength band and reflecting light in other color wavelength bands.

In contrast to this, an absorption filter has the properly of transmitting light in a specific wavelength band and absorbing light except the specific wavelength band. FIG. 3 shows an example of the transmittance (ordinate) of an absorption filter with respect to wavelength (abscissa). As shown in FIG. 3, for example, the red absorption filter 130 has the characteristic (R) of transmitting light in the red wavelength band and absorbing light in other color wavelength bands. Likewise, the green absorption filter 131 has the characteristic (G) of transmitting light in the green wavelength band and absorbing light in other color wavelength bands. In addition, likewise, the blue absorption filter 132 has the characteristic (B) of transmitting light in the blue wavelength band and absorbing light in other color wavelength bands.

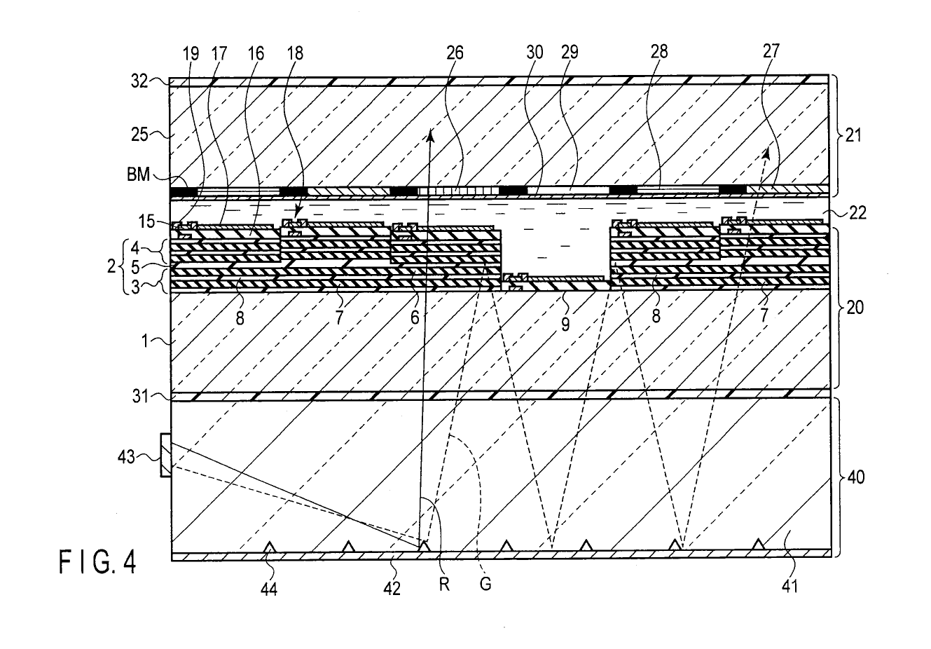

FIG. 4 is a sectional view showing the structure of the liquid crystal display apparatus according to the first embodiment. As described above, roughly speaking, the liquid crystal display apparatus is provided with an array substrate 20 and a counter substrate 21. The array substrate 20 and the counter substrate 21 are fixed at a proper distance through a spacer or the like. A liquid crystal layer 22 is held between the array substrate 20 and the counter substrate 21.

A red interference filter 6, a green interference filter 7, and a blue interference filter 8 are respectively formed at portions corresponding to red, green, and blue pixels on the counter surface side of a transparent glass substrate 1 as the base of the array substrate 20 with respect to the counter substrate 21. Referring to FIG. 4, the red interference filter 6, the green interference filter 7, and the blue interference filter 8 are collectively referred to as the interference filter 2.

The interference filter 2 in the case of FIG. 4 is a Fabry-Perot type interference filter, which includes a first reflecting layer 3, a spacer layer 5, and a second reflecting layer 4. The first reflecting layer 3 is formed by alternately stacking dielectric films having different refractive indices, e.g., silicon nitride films and silicon oxide films. This layer semi-transmits/reflects visible light. The spacer layer 5 is formed by stacking a plurality of dielectric members, e.g., silicon nitride films, between the first reflecting layer 3 and the second reflecting layer 4 so as to have different thicknesses for the respective colors to which the interference filter 2 corresponds. In other words, the spacer layer 5 is formed such that portions corresponding to the red interference filter 6, the green interference filter 7, and the blue interference filter 8 have different thicknesses. The second reflecting layer 4 is formed by alternately stacking dielectric films having different refractive indices, e.g., silicon nitride films and silicon oxide films. This layer semi-transmits/reflects visible light.

In the case of a general liquid crystal display apparatus, only one silicon oxide film or the like is formed as an undercoat layer on the glass substrate 1. The undercoat layer is formed to prevent diffusion of impurities from the glass substrate 1 or improve the flatness of the glass substrate 1. In this embodiment, the interference filter 2 is formed instead of an undercoat layer.

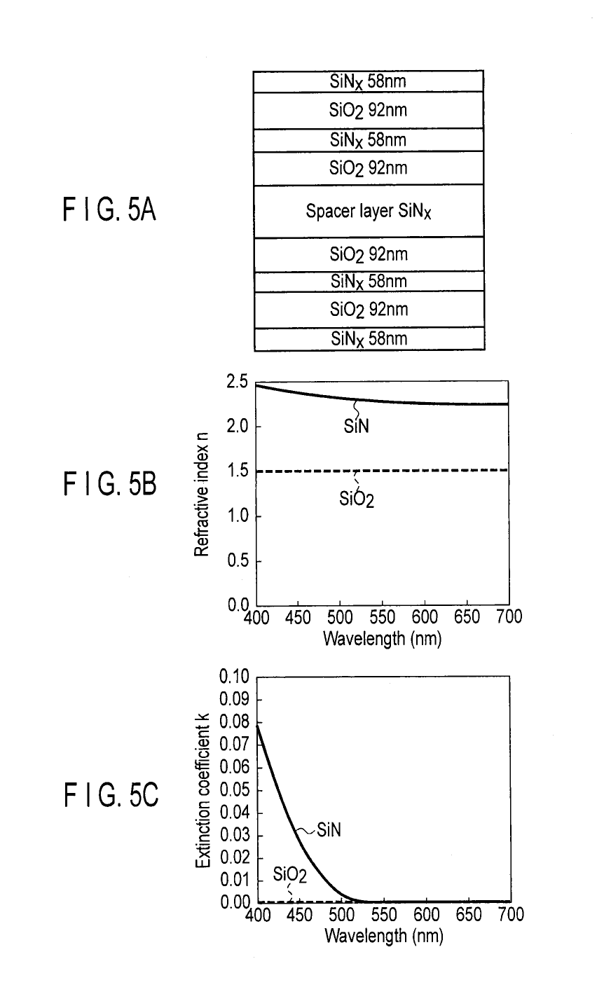

FIG. 5A shows an example of the arrangement of the interference filter 2. For example, in the case of the interference filter 2, silicon oxide films which form the first reflecting layer 3 and the second reflecting layer 4 each have a thickness of about 92 nm, and silicon nitride films which form the first reflecting layer 3 and the second reflecting layer 4 each have a thickness of about 58 nm.

FIG. 5B is a graph showing the wavelength (abscissa) dependence of the refractive index n (ordinate) as an optical constant of the interference filter 2 as an example. FIG. 5C is a graph showing the wavelength dependence of the extinction coefficient k as an optical constant of the interference filter 2 as an example. The silicon nitride film of the interference filter 2 as an example is the one that is adjusted to make the refractive index near a wavelength of 550 nm become 2.3. In this case, the spacer layer 5 for the formation of red, green, and blue color filters has a thickness of about 30 nm at a portion corresponding to the red interference filter 6, a thickness of about 115 nm at a portion corresponding to the green interference filter 7, and a thickness of about 78 nm at a portion corresponding to the blue interference filter 8.

Wiring portions each including a gate line 15, a gate insulating film 16, a pixel electrode 17 formed from a transparent conductive film, a thin-film transistor (transistor) 18, and a signal line 19 are formed on the interference filter 2, as shown in FIG. 4. The wiring portions are arranged on portions of the spacer layer 5 which respectively correspond to the red interference filter 6, the green interference filter 7, and the blue interference filter 8. That is, the plurality of thin-film transistors 18 respectively overlap the red pixel 110, the green pixel 111, the blue pixel 112, and the white pixel 113.

A wiring portion including the gate line 15, the gate insulating film 16, the pixel electrode 17 formed from a transparent conductive film, the thin-film transistor 18, and the signal line 19 is formed in place of the interference filter 2 on a portion, on the counter surface side of the glass substrate 1 with respect to the counter substrate 21, which corresponds to a white pixel 9.

A red absorption filter 26, a green absorption filter 27, and a blue absorption filter 28 of the second color filter are respectively formed on portions, of the counter surface side of a transparent glass substrate 25 as the base of the counter substrate 21 with respect to the array substrate 20, which respectively correspond to red, green, and blue pixels. The position of a white pixel 29 on the counter surface side of the glass substrate 25 with respect to the array substrate 20 corresponds to a portion on which no absorption filter is formed. A black matrix BM is formed at positions facing the wiring portions on the second color filter. The red absorption filter 26 faces the red interference filter 6 and transmits at least part of light passing through the red interference filter 6. The green absorption filter 27 faces the green interference filter 7 and transmits part of light passing through the green interference filter 7. The blue absorption filter 28 faces the blue interference filter 8 and transmits part of light passing through the blue interference filter 8. Each white pixel portion of the second color filter faces a portion of the first color filter on which no interference filter is formed, and transmits at least part of light passing through the portion of the first interference filter.

A common electrode 30 formed from a transparent electrode is formed on a surface of the portions of the red absorption filter 26, green absorption filter 27, blue absorption filter 28, and white pixel 29, which surface faces the array substrate 20.

A first polarizing plate 31 is provided on a surface of the array substrate 20 which does not face the counter substrate 21, and a second polarizing plate 32 is provided on a surface of the counter substrate 21 which does not face the array substrate 20.

The surface of the array substrate 20 which does not face the counter substrate 21 is provided with a backlight 40 through the first polarizing plate 31. The backlight 40 shown in FIG. 4 includes a lightguide plate 41, a reflecting plate 42, and a light source 43. Grooves 44 are formed in the lower surface of the lightguide plate 41. In addition, as the light source 43, for example, it is possible to use various kinds of light sources which can emit white light. For example, a white light-emitting diode can be used as the light source 43.

The operation of the liquid crystal display apparatus shown in FIG. 4 will be described. The light emitted from the light source 43 of the backlight 40 propagates in the lightguide plate 41 while being totally reflected. When this light strikes the grooves 44, the total reflection conditions are not met, and light emerges to the array substrate 20. This light reaches the glass substrate 1 through the first polarizing plate 31, is transmitted through the glass substrate 1, and strikes the first color filter.

In this case, when, for example, red light R of the light emitted from the light source 43 reaches the red interference filter 6 forming the first color filter, the red light R is transmitted through the red interference filter 6. In contrast, when the red light R reaches interference filters of other colors, the red light R is reflected to the backlight 40 side. This light R is reflected by the reflecting plate 42 again. In this manner, the red light R propagates in the lightguide plate 41 until it is transmitted through the red interference filter 6 while being multireflected.

Likewise, when, for example, green light G of the light emitted from the light source 43 reaches the green interference filter 7 forming the first color filter, the green light G is transmitted through the green interference filter 7. In contrast, when the green light G reaches interference filters of other colors, the green light G is reflected to the backlight 40 side. This light G is reflected by the reflecting plate 42 again. In this manner, the green light G propagates in the lightguide plate 41 until it is transmitted through the green interference filter 7 while being multireflected. Although not shown in FIG. 4, the same applies to blue light. That is, when blue light B of the light emitted from the light source 43 reaches the blue interference filter 8 forming the first color filter, the blue light B is transmitted through the blue interference filter 8. In contrast, when the blue light B reaches interference filters of other colors, the blue light B is reflected to the backlight 40 side. This light B is reflected by the reflecting plate 42 again. In this manner, the blue light B propagates in the lightguide plate 41 until it is transmitted through the blue interference filter 8 while being multireflected.

In addition, when the light emitted from the light source 43 reaches the portion of the white pixel 9, the light emerges without any change.

The light transmitted through the interference filter 2 reaches the liquid crystal layer 22 through the pixel electrode 17. The liquid crystal layer 22 is configured to change its alignment in accordance with the electric field generated between the pixel electrode 17 and the common electrode 30. Supplying a gate signal to the gate line 15 will turn on the thin-film transistor 18. Supplying a signal corresponding to a desired tone to the thin-film transistor 18 in the ON state through the signal line 19 will change the magnitude of the electric field between the pixel electrode 17 and common electrode 30. This changes the amount of light transmitted through the liquid crystal layer 22. The light emerging from the liquid crystal layer 22 then strikes the second color filter.

In this case, when the red light R of the light emerging from the liquid crystal layer 22 reaches the red absorption filter 26 forming the second color filter, light of the red light R which falls within the specific wavelength band shown in FIG. 3 is transmitted through the red absorption filter 26, while the red absorption filter 26 absorbs light in other wavelength bands.

Likewise, when the green light G of the light emerging from the liquid crystal layer 22 reaches the green absorption filter 27 forming the second color filter, light of the green light G which falls within the specific wavelength band shown in FIG. 3 is transmitted through the green absorption filter 27, while the green absorption filter 27 absorbs light in other wavelength bands. In addition, likewise, when the blue light B of the light emerging from the liquid crystal layer 22 reaches the blue absorption filter 28 forming the second color filter, light of the blue light B which falls within the specific wavelength band shown in FIG. 3 is transmitted through the blue absorption filter 28, while the blue absorption filter 28 absorbs light in other wavelength bands.

Furthermore, when the light emitted from the light source 43 reaches the portion of the white pixel 29, the light emerges without any change.

The light emerging from the second color filter is transmitted through the glass substrate 25 and emerges except the liquid crystal display apparatus through the second polarizing plate 32.

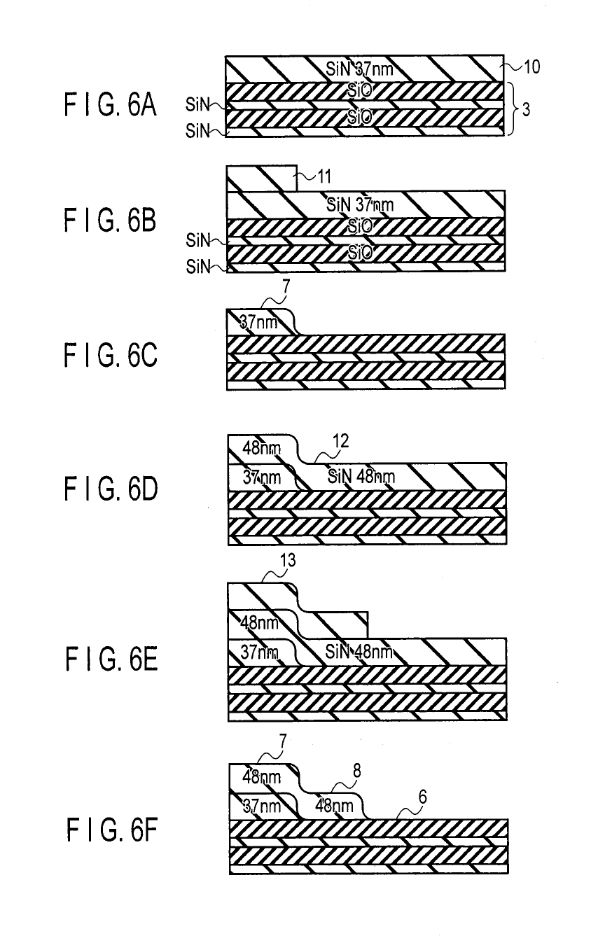

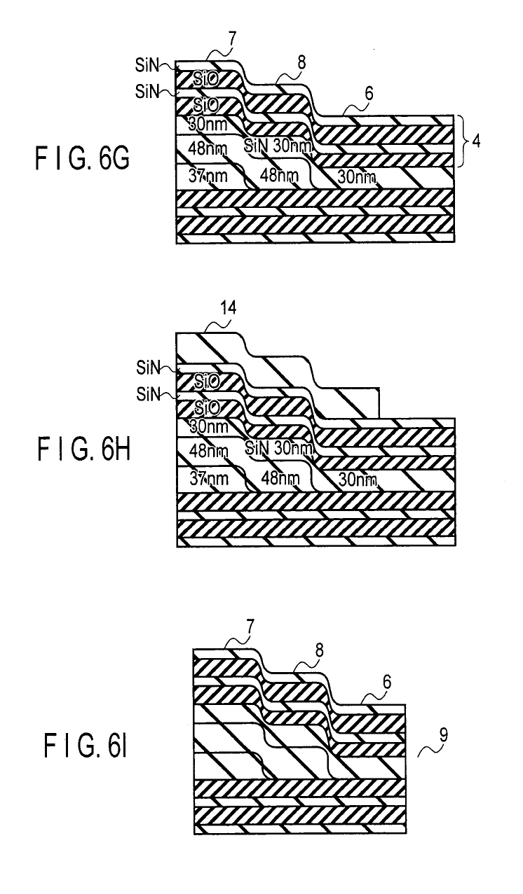

FIGS. 6A to 6I are views for explaining a manufacturing process for the first color filter according to this embodiment. First of all, as shown in FIG. 6A, a silicon nitride film, a silicon oxide film, a silicon nitride film, and a silicon oxide film are consecutively formed on the glass substrate 1 so as to form the first reflecting layer 3 formed from the four layers on the entire surface. The dielectric films forming the first reflecting layer 3 can be consecutively formed by CVD (Chemical Vapor Deposition) by controlling a gas pressure and the like.

Subsequently, a silicon nitride film 10 having a thickness of about 37 nm is formed on the entire surface of the first reflecting layer 3 by CVD. After the silicon nitride film 10 is formed on the entire surface, a resist 11 is patterned on the silicon nitride film 10 by photolithography, as shown in FIG. 6B. As shown in FIG. 6C, a spacer layer is patterned by chemical dry etching, and then the resist 11 is removed. A portion left without being dry-etched becomes the green interference filter 7. If the selectivity between a silicon nitride film and a silicon oxide film is sufficiently high, i.e., the etching rate of a silicon oxide film is sufficiently lower than that of a silicon nitride film, in chemical dry etching, it is possible to selectively etch only the silicon nitride film while suppressing etching damage to the silicon oxide film as an underlying film. In practice, the etching selectivity between them is about 5 to 10, and hence etching damage to the silicon oxide film cannot be ignored. In order to completely remove the silicon nitride film on the silicon oxide film by dry etching, therefore, it is preferable to completely remove the silicon nitride in an over-etching manner by setting a relatively long etching time.

After dry etching of the 37 nm thick silicon nitride film, a silicon nitride film 12 having a thickness of about 48 nm is formed on the entire surface, as shown in FIG. 6D. After the silicon nitride film 12 is formed on the entire surface, a resist 13 is patterned on the silicon nitride film 12 by photolithography, as shown in FIG. 6E. As shown in FIG. 6F, after a spacer layer is patterned by chemical dry etching, the resist 13 is removed. The portion where the two silicon nitride films are stacked on each other as shown in FIG. 6F becomes the green interference filter 7. A one-layer portion becomes the blue interference filter 8. A portion where no silicon nitride film is stacked becomes the red interference filter 6. As shown in FIG. 6F, in this embodiment, the area of the portion serving as the red interference filter 6 is larger than that of the portion serving as the green interference filter 7 and that of the portion serving as the blue interference filter 8. This is for the purpose of forming a white pixel portion in a subsequent step.

As shown in FIG. 6G, then, a silicon nitride film having a thickness of about 30 nm, which is equal to the thickness of the red interference filter 6, is formed on the entire surface, and the second reflecting layer 4 formed from a silicon oxide film and a silicon nitride film is consecutively formed, thereby forming the Fabry-Perot type interference filter 2. The thickness of the spacer layer 5 on a portion corresponding to the green interference filter 7 becomes 37+48+30=115 nm, the thickness of the spacer layer 5 on a portion corresponding to the blue interference filter 8 becomes 48+30=78 nm, and the thickness of the spacer layer 5 on a portion corresponding to the red interference filter 6 becomes 30 nm. In this manner, the interference filter 2 is obtained, with the spacer layer 5 having the thicknesses shown in FIG. 5A.

Subsequently, a white pixel portion is formed. For this purpose, as shown in FIG. 6H, a resist 14 is patterned on portions corresponding to the interference filters 6, 7, and 8 of the second reflecting layer 4 by photolithography. As shown in FIG. 6I, then, the first color filter shown in FIG. 4 is formed by removing all the silicon nitride film and silicon oxide film corresponding to the portion of the white pixel 9 by etching.

In the case shown in FIGS. 6A, 6B, 6C, 6D, 6E, 6F, 6G, 6H, and 6I, when forming a portion serving as the white pixel 9, this technique forms the same structure as that of the red interference filter 6 at a portion serving as the white pixel 9, and removes all the interference filter from the portion serving as the white pixel 9 by etching in the final step. In contrast to this, it is possible to form a portion serving as the white pixel 9 by masking the portion serving as the white pixel 9 with a metal or the like in advance, forming the interference filter 2 on portions other than the masked portion, and then removing the metal as the mask by etching or the like.

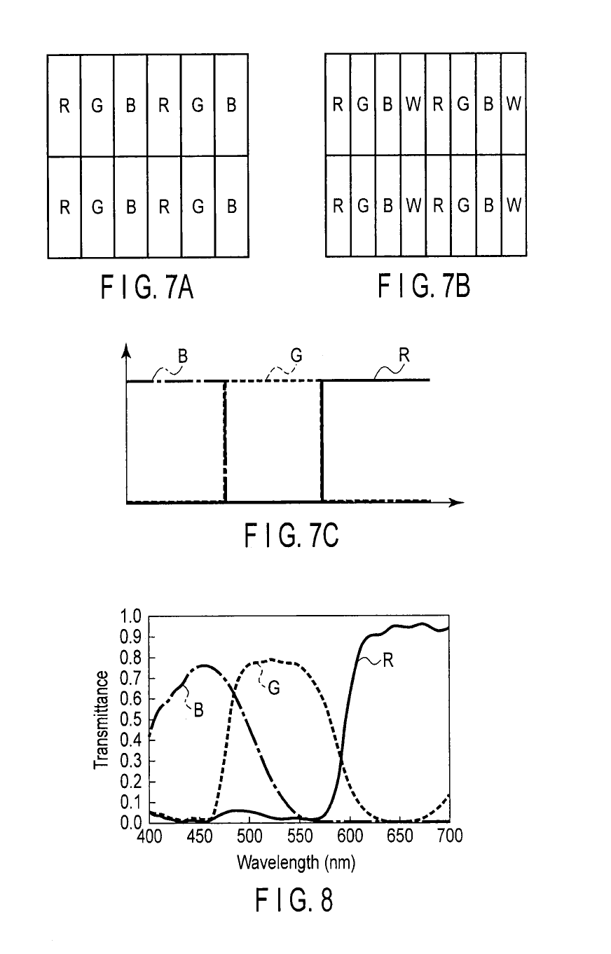

FIGS. 7A and 7B are views for explaining the effect of improving light utilization efficiency by adding white pixels. FIG. 7A is a view showing the arrangement of a filter when one pixel is formed from only red, green, and blue sub-pixels. FIG. 7B is a view showing the arrangement of a filter when one pixel is formed from red, green, blue, and white sub-pixels.

For comparison, consider the efficiency obtained by using only absorption filters. Assume that in this case, the transmittance of an absorption filter is in an ideal state as shown in FIG. 7C. An absorption filter in an ideal state transmits 100% of light in the transmission region and absorbs light in the absorption region. When performing white display by arranging the ideal absorption filter shown in FIG. 7C into the filter arrangement shown in FIG. 7A, ⅓ of incident light emerges from the liquid crystal display apparatus. In contrast, when performing white display by arranging the ideal absorption filter shown in FIG. 7C into the filter arrangement shown in FIG. 7B, ⅓ of incident light emerges from each of red, green, and blue pixels in the liquid crystal display apparatus, and light emerges from each white pixel without any loss. Assuming that each pixel has the same size in FIGS. 7A and 7B, the area of each sub-pixel in FIG. 7B is ¾ of the area of each sub-pixel in FIG. 7A. In the case shown in FIG. 7B, therefore, the efficiency of light passing through the absorption filter is given by ¼+(¾)×(⅓)=½. That is, in the case shown in FIG. 7B, when performing white display, the brightness becomes 1.5 times that in the case of FIG. 7A. In other words, when performing display operation with the same brightness, the power consumption can be reduced to ⅔.

In contrast to this, consider the efficiency of an interference filter. Assume that in this case, the transmission/reflection characteristics of the interference filter are in an ideal state. At this time, all the light can be brought out. That is, when each pixel like that shown in FIG. 7B is formed by using an ideal interference filter, the efficiency can be increased three times that when using only red, green, and blue absorption filters, and can be increased two times that when using red, green, and blue absorption filters and white pixels.

For comparison, the efficiency of an actual color filter is considered. Assume that an absorption filter having the characteristics shown in FIG. 8 is arranged and used in an arrangement like that shown in FIG. 7A. In this case, the filter transmits about 27% of incident light. When obtaining such efficiency, there is no consideration of loss through a polarizing plate, and it is assumed that the opening ratio is 100%. When a three-color filter is formed, it is possible to obtain the above efficiency by calculating a transmission spectrum assuming that ⅓ of incident light is transmitted through each of absorption filters of the respective colors and converting the transmission spectrum into a luminance. In this case, when the absorption filter shown in FIG. 8 is used, the NTSC ratio representing a color gamut becomes 60%. Subsequent comparison of efficiencies will be performed with an NTSC ratio of 60%. Since the efficiency increases as the color gamut narrows, it is necessary to keep the color gamut unchanged to properly evaluate efficiencies.

An efficiency is obtained when an absorption filter having the characteristics shown in FIG. 8 is arranged and used in the manner shown in FIG. 7B. In this case, an efficiency is obtained in the same manner as in the case of FIG. 7A, i.e., by calculating a transmission spectrum assuming that ¼ of incident light is transmitted through each of the absorption filters of the respective colors and a white pixel portion. When obtaining an efficiency in this manner, the efficiency becomes about 46%. This indicates that the efficiency is improved by 1.7 times that when no white pixel is provided.

An efficiency is then calculated when interference filters are used. As an example of setting a color gamut to an NTSC ratio of 60%, interference filters having the characteristics shown in FIGS. 2A and 2B and absorption filters having the characteristics shown in FIG. 3 are used. When using an interference filter, it is necessary to add the step of reusing light reflected by the interference filter. This makes it impossible to calculate an efficiency by simple calculation. For this reason, an efficiency is obtained by numerical calculation. The efficiency obtained as a result of the above processing was 64%. That is, it is possible to achieve an efficiency 2.4 times that when sub-pixels are formed by using only absorption filters of three colors, and 1.4 times that when absorption filters of three colors and white pixels are provided.

Note that the first embodiment has exemplified the case in which no interference filters or absorption filters are formed on white pixel portions. Since white pixels are pixels which are provided to improve luminance, an improvement in efficiency like that described above can be achieved even by using filters of green with the highest luminance sensitivity to the human eye as absorption filters. Although no absorption filter is formed on the pixel 29 in FIG. 4, a green absorption filter may be formed.

As described above, according to this embodiment, it is possible to improve light utilization efficiency and obtain a high power saving effect by forming white pixels while reusing interference filters.

### Second Embodiment

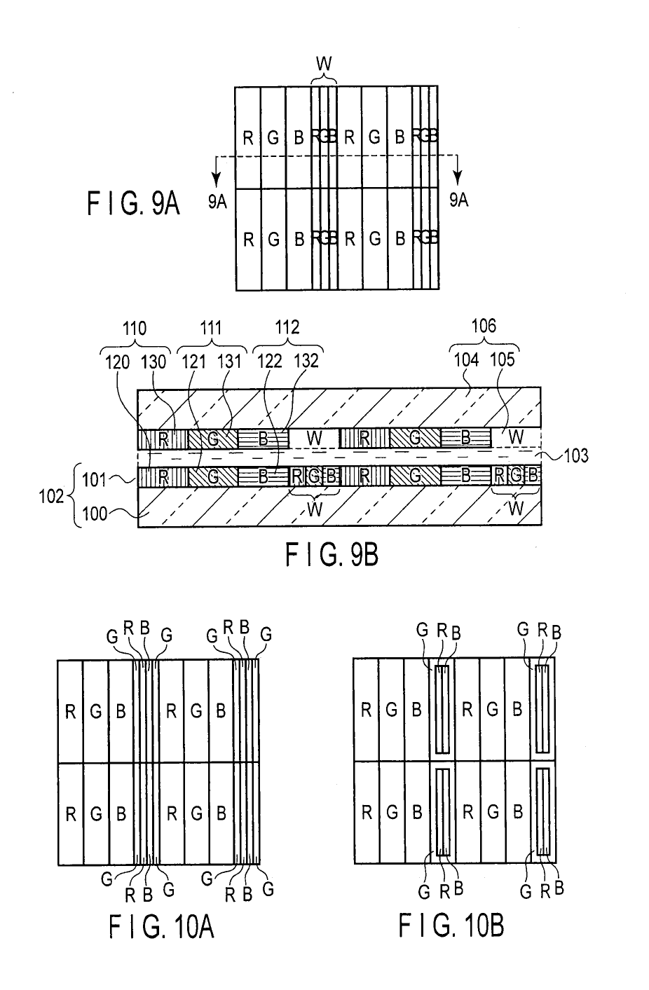

The second embodiment will be described. In the first embodiment, white pixel portions are transparent pixels on which no interference filters or absorption filters are formed. In contrast to this, the first color filter in the second embodiment is configured to form white pixel portions by forming interference filters of three colors, i.e., red, green, and blue, as shown in FIGS. 9A and 9B. That is, each white pixel portion includes red, green, and blue interference filters. Light beams passing through these interference filters are combined into white light. FIG. 9A is plan view of an interference filter 101 in the second embodiment. FIG. 9B is a sectional view taken along a line 9A-9A. The structure of a wiring portion in the second embodiment is the same as that shown in FIG. 4. That is, a plurality of sub-pixels formed on a white pixel portion are not independently driven. Note that the arrangement of the second color filter is the same as that in the first embodiment.

Forming each white pixel portion by using red, green, and blue interference filters eliminates the necessity of the steps shown in FIGS. 6H and 6I. That is, applying the same steps as those shown in FIGS. 6A, 6B, 6C, 6D, 6E, 6F, and 6G to each white pixel portion eliminates the necessity of last etching.

The second embodiment need not always use the arrangement shown in FIGS. 9A and 9B as long as red, green, and blue interference filters are arranged on each white pixel portion with almost the same area. For example, the color arrangement of red, green, and blue sub-pixels and white sub-pixel may be changed. FIGS. 10A and 10B each show a case in which interference filters of the same color (green in FIGS. 10A and 10B) are arranged on the peripheries of a black matrix BM at white sub-pixels. Such an arrangement is used because wiring portions are formed on an interference filter 2 at positions corresponding to the black matrix BM. As shown in FIG. 4, the interference filter 2 is formed so as to have different thicknesses in accordance with colors. For this reason, if interference filter portions corresponding to the black matrix BM and its peripheries are made to have different colors, the formation positions of wiring portions differ depending on pixels when viewed in the height direction. In this case, wiring portions are formed on stepped portions, and the wirings tend to be disconnected. For this reason, interference filter portions corresponding to the black matrix BM and its peripheries preferably have the same color. FIGS. 10A and 10B each show a case in which interference filters on the peripheries of the black matrix BM are green interference filters each having the largest thickness. Note that FIG. 10B shows a case in which green interference filters are arranged on all the peripheral portions of the black matrix BM as well as portions in the longitudinal direction of the filters. In this case, the red, green, and blue interference filters preferably have the same area.

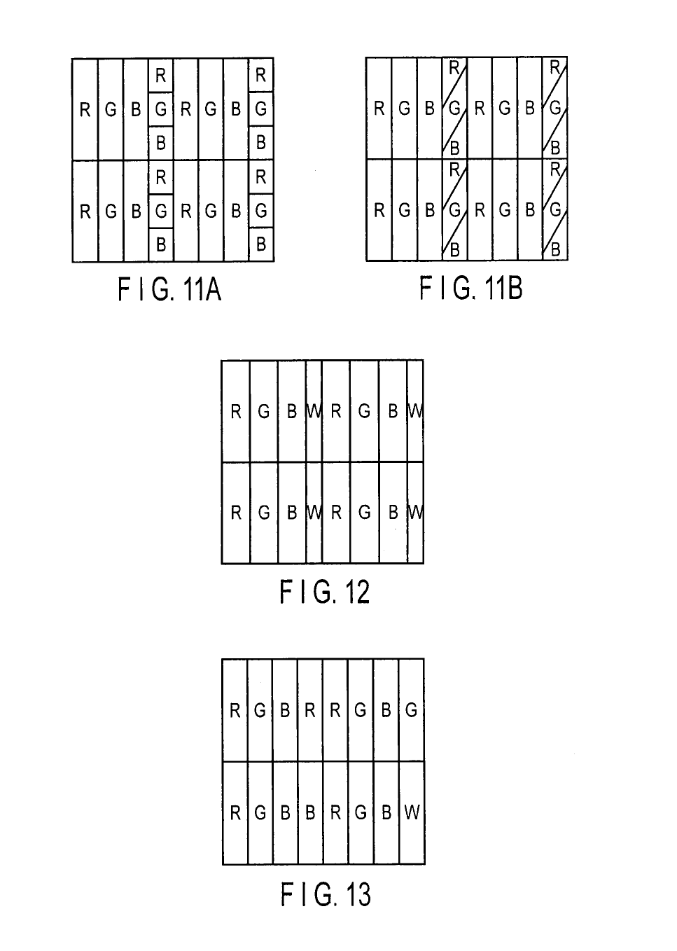

FIGS. 9A and 9B and FIGS. 10A and 10B each show a case in which red, green, and blue interference filters are formed in a vertical stripe pattern on portions corresponding to white pixel portions. In contrast to this, as shown in FIG. 11A, red, green, and blue interference filters are formed in a horizontal stripe pattern on each white pixel portion. As shown in FIG. 11B, red, green, and blue interference filters may be formed in an oblique stripe pattern on each white pixel portion. As the arrangement of interference filters in this embodiment, arrangements other than those described above can be used. That is, if each white pixel portion is constituted by interference filters of a plurality of colors (which need not always be constituted by interference filters of three colors, i.e., red, blue, and green), this is also incorporated in all the embodiments.

In addition, in the above case, red, blue, and green interference filters are formed one by one on each white pixel portion. However, a plurality of sets of red, blue, and green interference filters may be formed on one white pixel.

When each white pixel portion is constituted by interference filters of a plurality of colors, the efficiency like that described above is about 45%, assuming that red, blue, and green interference filters have the same area. Note that in this efficiency calculation, each interference filter has the characteristics shown in FIGS. 2A and 2B, and each absorption filter has the characteristics shown in FIG. 3. As a result, the efficiency is almost the same as that when absorption filters of three colors are used, and each white pixel is a transparent pixel, and is about 1.6 times that when absorption filters of three colors are used, and no white pixel is provided. Using interference filters having characteristics close to those in an ideal state can obtain a higher efficiency.

In particular, when sub-pixels arranged near white pixels have the same color as that of some of interference filters forming white pixels which are in contact with the sub-pixels, the boundaries between the white pixels and the adjacent sub-pixels have no stepped portions. For this reason, providing a thin-film transistor 18 on the boundary between two sub-pixels can form the thin-film transistor 18 on a flat surface. This will prevent the thin-film transistor from deteriorating in reliability.

As described above, this embodiment can improve light utilization efficiency and obtain a large power saving effect by forming white pixels while reusing light with interference filters. In addition, the embodiment eliminates the necessity of an etching step of forming transparent pixels by forming white pixel portions using interference filters of a plurality of colors instead of forming them into transparent pixels.

Note that the second embodiment has exemplified the case in which each white pixel portion is formed by interference filters of three colors, and no absorption filters are formed. Since white pixels are pixels which are provided to improve luminance, an improvement in efficiency like that described above can be achieved even by using filters of green with the highest luminance sensitivity to the human eye as absorption filters. Although no absorption filter is formed on each white pixel in the case of FIG. 9B, a green absorption filter may be formed.

### Third Embodiment

The third embodiment will be described. FIG. 12 is a view showing the arrangement of interference filters in the third embodiment. As shown in FIG. 12, in the third embodiment, the area of each white pixel portion is smaller than that of each of sub-pixels of other colors. In this case, the arrangement of the white pixels shown in FIG. 12 may be that of transparent pixels described in the first embodiment, or that of interference filters of a plurality of colors like that described in the second embodiment.

As in the first and second embodiments, when the area of each white pixel is the same as that of each of sub-pixel portions of other colors, the efficiency of white display increases, but the efficiency of color display decreases. When performing single-color display of red, green, or blue, in particular, the efficiency decreases. When one pixel is constituted by sub-pixels of four colors, i.e., red, green, blue, and white with the red, green, blue, and white sub-pixels having the same area, the area of each sub-pixel becomes ¾ that when one pixel is constituted by sub-pixels of three colors, i.e., red, green, and blue. Considering, for example, single-color display of red, using sub-pixels of four colors, i.e., red, green, blue, and white, requires a power consumption 4/3 (about 1.3 times) that in the above case to perform display with the same brightness. As compared with the case of absorption filters of three colors and white pixels, the efficiency of white display may become 1.7 times that when white pixels are used, but the efficiency of color display may decrease to 1/1.3. Each white pixel has the same area as that of each of sub-pixels of other colors, the total efficiency becomes about 1.3 times that in the above case. In order to converge this total efficiency to a certain value, the area of each white pixel may be limited to some extent. For example, in order to improve the total efficiency to about 1.5 times, the area ratio between each white pixel and each of sub-pixels of other colors may be set to about 2:8.

When using interference filters, each white pixel outputs not only ¼ of incident light, which corresponds to the area ratio, but also part of light reflected and recycled by other interference filters. Each white pixel outputs a larger amount of light than when a while pixel is added to absorption filters of three colors. For this reason, using interference filters will suppress a deterioration in efficiency when the area of each white pixel is reduced.

As described above, this embodiment can improve light utilization efficiency and obtain a large power saving effect by forming white pixels while reusing light with interference filters. In addition, the embodiment can improve the efficiency of color display by making the area of each white pixel smaller than that of each of sub-pixels of other colors.

Note that the third embodiment has exemplified the case in which no absorption filters are formed on white pixels. Since white pixels are pixels which are inserted to improve luminance, an improvement in efficiency like that described above can be achieved even by using filters of green with the highest luminance sensitivity to the human eye as absorption filters. As white pixels, green absorption filters may be formed.

### Fourth Embodiment

The fourth embodiment will be described. FIG. 13 is a view showing the arrangement of interference filters in the fourth embodiment. The second embodiment has exemplified the case in which interference filters of a plurality of colors are formed on each white pixel portion. In contrast to this, the fourth embodiment exemplifies a case in which a single-color interference filter is formed on each white pixel portion, and each white pixel is formed by a plurality of adjacent pixels.

FIG. 13 shows a case in which four pixels form one white pixel. With regard to the upper left pixel in FIG. 13, a red sub-pixel is formed on a white pixel, and a red interference filter is formed on the portion. With regard to the upper right pixel in FIG. 13, a green sub-pixel is formed on a white pixel, and a green interference filter is formed on the portion. With regard to the lower left pixel in FIG. 13, a blue sub-pixel is formed on a white pixel, and a blue interference filter is formed on the portion. In addition, with regard to the lower right pixel in FIG. 13, a white sub-pixel is formed on a white pixel (formed by placing a transparent pixel or interference filters of a plurality of colors).

When performing white display, the upper left white pixel in FIG. 13 performs red display, the upper right white pixel in FIG. 13 performs green display, the lower left white pixel in FIG. 13 performs blue display, and the lower right white pixel in FIG. 13 performs white display. In this case, four white pixels can be regarded to averagely perform white display.

The fourth embodiment exemplifies a case in which no absorption filter is formed on the lower right white pixel portion in FIG. 13. Obviously, when the upper left, upper right, and lower left white pixels in FIG. 13 respectively perform red display, green display, and blue display, the absorption filters of the respective colors are used. Since white pixels are pixels which are provided to improve luminance, an improvement in efficiency like that described above can be achieved even by using filters of green with the highest luminance sensitivity to the human eye as absorption filters. As the lower right white pixel in FIG. 13, a green absorption filter may be formed.

As described above, this embodiment can improve light utilization efficiency and obtain a large power saving effect by forming white pixels while reusing light with interference filters. In addition, according to the embodiment, forming each white pixel by using a plurality of sub-pixels can also suppress a deterioration in efficiency by reducing the area of each white pixel.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A liquid crystal display apparatus comprising:
an interference filter including a first area and a second area, the first area transmitting light in a first wavelength band and reflecting light except the first wavelength band, and the second area transmitting white light;
a transistor provided on the first area and the second area;
a substrate facing the interference filter; and
a liquid crystal layer provided between the interference filter and the substrate.

2. The apparatus of claim 1, wherein the interference filter includes a third area and a forth area, the third area transmitting light in a second wavelength band and reflecting light except the second wavelength band, and the fourth area transmitting light in a third wavelength band and reflecting light except the third wavelength band, and
the liquid crystal display apparatus further comprises a transistor provided on the third area and the fourth area.

3. The apparatus of claim 2, wherein the second area includes a first portion, a second portion and a third portion, the first portion transmitting light in the first wavelength band and reflecting light except the first wavelength band, the second portion transmitting light in the second wavelength band and reflecting light except the second wavelength band, and the third portion transmitting light in the third wavelength band and reflecting light except the third wavelength band.

4. The apparatus of claim 3, wherein the first portion is provided adjacent to the first area, and
at least one of the transistor provided on the first area and the transistor provided on the second area is formed to be overlapped on a boundary between the second area and the first area.

5. The apparatus of claim 1, wherein the second area has an area smaller than that of the first area.

6. The apparatus of claim 1, further comprising an absorption filter which is placed at a position facing the interference filter of the substrate through a liquid crystal layer and includes a fifth area and a sixth area, the fifth are facing the first area and transmitting at least part of light transmitted through the first area, and the sixth area facing the second area and transmitting at least part of light transmitted through the second area.

7. The apparatus of claim 6, wherein the absorption filter includes a seventh area and an eighth area, the seventh area facing the third area and transmitting at least part of light transmitted through the third area, and the eighth area facing the fourth area and transmitting at least part of light transmitted through the fourth area.

8. The apparatus of claim 6, wherein the sixth area transmits green light.
